(19) United States
(12) Patent Application Publication
(10) Pub. No.: US 2025/0108785 A1
(43) Pub. Date: Apr. 3, 2025

(54) BRAKE SYSTEM WITH ENHANCED REVERSE MODULATED BRAKE CONTROL

(71) Applicant: Caterpillar Inc., Peoria, IL (US)

(72) Inventors: Edward W. MATE, Manhattan, IL (US); Steven E. JOHNSON, Metamora, IL (US)

(73) Assignee: Caterpillar Inc., Peoria, IL (US)

(21) Appl. No.: 18/374,715

(22) Filed: Sep. 29, 2023

(51) Int. Cl. B60T 13/68; B60T 7/02; B60T 7/12; B60T 8/1755; B60T 13/14; B60T 13/22; B60T 15/02

(52) U.S. Cl. CPC B60T 13/686; B60T 7/12; B60T 8/17554; B60T 13/14; B60T 13/22; B60T 15/028; B60T 7/02; B60T 2220/03; B60T 2230/03; B60T 2240/02; B60T 2250/00; B60T 2270/10; B60T 2270/203; B60T 2270/306

(57) ABSTRACT

A brake system of a machine may receive stability data associated with multiple wheels of the machine. The brake system may initiate, based on the stability data, an automatic electrohydraulic braking operation associated with a brake that is operatively connected to a wheel, of the multiple wheels. The brake may be movable from a de-applied position to an applied position to apply a brake force to the wheel. The brake system may prevent, based on initiating the automatic electrohydraulic braking operation, an operator input from controlling a brake pressure that is supplied to the brake via a valve configuration of the brake system. The brake system may decrease, based on an electrohydraulic input, the brake pressure that is supplied to the brake, via the valve configuration, to move the brake from the de-applied position to the applied position to apply the brake force to the wheel.

### TECHNICAL FIELD

The present disclosure relates generally to a brake system for a machine, and, for example, to a brake system, for a machine, having enhanced reverse modulated brake control.

### BACKGROUND

A brake system is used to control braking of a machine (e.g., a work machine associated with a worksite). In some cases, the machine is equipped with reverse modulated brakes that are controlled by a reverse modulated brake system. Reverse modulated brakes are brakes that are de-applied (e.g., do not provide a brake force) when the brakes receive pressurized hydraulic fluid (e.g., from the brake system) and that are applied (e.g., provide a brake force) when no pressure is supplied to the reverse modulated brakes. In a typical reverse modulated brake system, each wheel (or other traction device) of the machine is operatively connected to a reverse modulated brake, each reverse modulated brake is operatively connected to a single hydro-mechanical control valve (e.g., a brake pedal valve of the machine), and the single hydro-mechanical control valve is operatively connected to a single electrohydraulic control valve (e.g., a single solenoid valve) via a single circuit.

Accordingly, to implement a braking operation, a typical reverse modulated brake system simultaneously provides a brake pressure, using either the single hydro-mechanical control valve or the single electrohydraulic control valve, to all reverse modulated brakes, which causes all reverse modulated brakes to simultaneously apply a brake force to all wheels of the machine. Because the reverse modulated brake system simultaneously provides the brake pressure to all reverse modulated brakes, the reverse modulated brake system cannot independently control a brake pressure that is supplied to the reverse modulated brakes.

In turn, the reverse modulated brake system cannot independently control a brake force that is applied to the wheels (or the other traction devices) of the machine (e.g., by the reverse modulated brakes). As a result, the reverse modulated brake system cannot provide electrohydraulic braking operations that require independent control of the brake force that is applied to the wheels (e.g., via the reverse modulated brakes), such as traction control system braking operations and dynamic stability control braking operations.

Furthermore, a typical reverse modulated brake system cannot override hydro-mechanical braking operations (e.g., braking operations that are controlled via the control valve and that are based on an operator input) that are being performed by the brake system. For example, if the reverse modulated brake system uses the hydro-mechanical control valve to simultaneously provide the brake pressure to all reverse modulated brakes based on the operator input, then the reverse modulated brake system cannot use the electrohydraulic control valve to simultaneously provide the brake pressure to all reverse modulated brakes (e.g., based on an electrohydraulic input) because the operator input cannot be blocked. As a result, the reverse modulated brake system cannot provide an electrohydraulic braking operation that requires an operator input to be blocked to implement the electrohydraulic braking operation, such as an antilock brake system (ABS) braking operation.

U.S. Pat. No. 3,880,473 (“the '473 patent”) describes a brake control system for a towed vehicle, such as a trailer vehicle that is towed by a tractor vehicle. The '473 patent describes that the brake control system includes an emergency control valve that detects an air pressure in an emergency line that is connected between the trailer vehicle and the tractor vehicle. If the air pressure in the emergency line falls below a predetermined level, then the emergency control valve applies brakes of the trailer vehicle.

### SUMMARY

Some implementations described herein relate to a brake system, of a machine, having enhanced reverse modulated brake control of a machine. The brake system may include a reverse modulated brake operatively connected to a wheel of the machine; a relay valve, in fluid communication with the reverse modulated brake, for supplying, to the reverse modulated brake, at least one of a de-apply pressure that causes the reverse modulated brake to be in a de-applied position or an apply pressure that causes the reverse modulated brake to be in an applied position, wherein the apply pressure is based on at least one of a hydro-mechanical pressure signal or an electrohydraulic pressure signal, and wherein the apply pressure is lower than the de-apply pressure; a hydraulic logic element, in fluid communication with the relay valve, for supplying the at least one of the hydro-mechanical pressure signal or the electrohydraulic pressure signal to the relay valve, wherein the hydraulic logic element includes a first inlet and a second inlet; a hydro-mechanical valve, in fluid communication with the first inlet, for outputting the hydro-mechanical pressure signal to the first inlet; an electrohydraulic valve, in fluid communication with the second inlet, for outputting the electrohydraulic pressure signal to the second inlet; and a blocking valve, in fluid communication with the hydraulic logic element and the hydro-mechanical valve, that is movable between a closed position and an open position, wherein, when the blocking valve is in the closed position, the hydro-mechanical valve is not in fluid communication with the first inlet, and wherein the first inlet is in fluid communication with a tank associated with the brake system.

Some implementations herein relate to a method for enhanced reverse modulated brake control for a machine, comprising: receiving, by a brake system of the machine, stability data associated with multiple wheels of the machine; initiating, by the brake system and based on the stability data, an automatic electrohydraulic braking operation associated with a brake that is operatively connected to a wheel, of the multiple wheels, wherein the brake is movable from a de-applied position to an applied position to apply a brake force to the wheel; preventing, by the brake system and based on initiating the automatic electrohydraulic braking operation, an operator input from controlling a brake pressure that is supplied to the brake via a relay valve of the brake system; and decreasing, by the brake system and based on an electrohydraulic input, the brake pressure that is supplied to the brake, via the relay valve, to move the brake from the de-applied position to the applied position to apply the brake force to the wheel.

Some implementations herein relate to a machine, having one or more wheels, comprising a brake system, the brake system including: a relay valve in fluid communication with a brake that is operatively connected to a wheel, of the one or more wheels, wherein the relay valve is associated with providing, to the brake, at least one of: a release brake pressure associated with maintaining the brake in a de-applied position, or a modulated brake pressure, that is less than the release brake pressure, associated with causing the brake to move from the de-applied position to an applied position to apply a brake force to the wheel, and wherein the modulated pressure is based on at least one of a hydro-mechanical pressure signal or an electrohydraulic pressure signal; a hydro-mechanical valve in fluid communication with the relay valve, wherein the hydro-mechanical valve provides, and the relay valve receives, the hydro-mechanical pressure signal in response to receiving a hydro-mechanical input; an electrohydraulic valve in fluid communication with the relay valve, wherein the electrohydraulic valve provides, and the relay valve receives, the electrohydraulic pressure signal in response to receiving an electronic input; and a blocking valve positioned in fluid communication between the hydro-mechanical valve and the relay valve, wherein the blocking valve is movable between a closed position that prevents the relay valve from receiving the hydro-mechanical pressure signal from the hydro-mechanical valve and an open position that enables the relay valve to receive the hydro-mechanical pressure signal from the hydromechanical valve.

### BRIEF DESCRIPTION OF THE DRAWINGS

FIG. 1 is a diagram of an example machine described herein.

FIGS. 2-4 are diagrams of example brake systems with enhanced reverse modulated brake control described herein.

FIG. 5 is a flowchart of an example process relating to enhanced reverse modulated brake control.

### DETAILED DESCRIPTION OF EXAMPLE EMBODIMENTS

The following detailed description of example implementations refers to the accompanying drawings. The same reference numbers in different drawings may identify the same or similar elements.

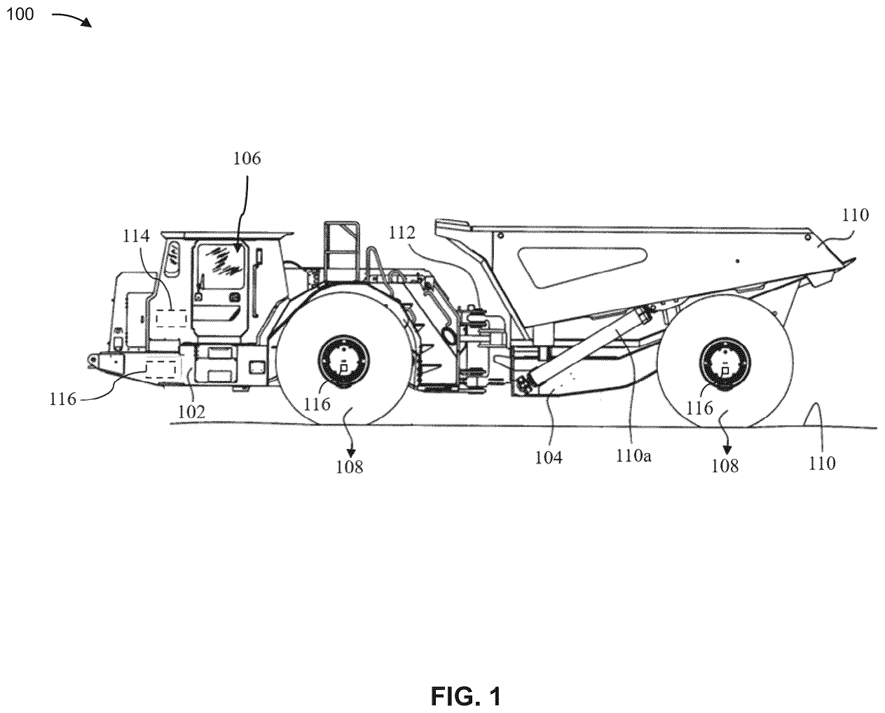

FIG. 1 is a diagram of an example machine 100 having a brake system with enhanced reverse modulated brake control, as described in more detail elsewhere herein. As shown in FIG. 1, the machine 100 is embodied as an underground articulated truck (UAT) (e.g., that may be employed at a worksite, among other examples). Although the machine 100 of FIG. 1 is shown and described as being a UAT, the machine 100 may be any suitable machine (e.g., a wheel loader, a dump truck, a backhoe loader, and/or a skid-steer loader, among other examples) that is employable at any suitable worksite (e.g., a construction site, a landfill, and/or a quarry, among other examples).

As further shown in FIG. 1, the machine 100 includes a front frame 102, a rear frame 104, an operator station 106 (e.g., an operator cab), traction devices 108, and a dump body 110. Although the traction devices 108 are shown as wheels in FIG. 1, the traction device 108 may be any suitable traction devices, such as tracks and/or rollers, among other examples. The front frame 102 and the rear frame 104 are operatively connected (e.g., pivotably connected) to one another by an articulation joint 112.

As further shown in FIG. 1, the operator station 106 is supported by the front frame 102. In some implementations, the operator station 106 may include one or more operator interfaces (e.g., one or more proportional-type controllers, pedals, steering wheels, multi-axis joysticks, knobs, push-pull devices, and/or switches, among other examples), as described in more detail elsewhere herein. As an example, an operator (not shown) of the machine 100 may interact with the one or more operator interfaces to provide one or more operator inputs (e.g., one or more braking operation inputs and/or one or more steering operation inputs, among other examples). For example, the operator may depress a brake pedal that causes a brake pedal sensor to generate an operator braking input (e.g., based on a displacement of the brake pedal).

As further shown in FIG. 1, the traction devices 108 are rotatably supported by the front frame 102 and the rear frame 104 (e.g., a set of front wheels may be rotatably supported by the front frame 102 and a set of rear wheels may be rotatably supported by the rear frame 104). In some implementations, the traction devices 108 may each be operatively connected to a reverse modulated brake, as described in more detail elsewhere herein.

As further shown in FIG. 1, the dump body 110 is supported by the rear frame 104. In some implementations, the dump body 110 may include an actuator (e.g., shown as a hydraulic cylinder 110a in FIG. 1) to raise and/or lower the dump body. The dump body 110 may be configured to receive a payload (e.g., ore, minerals, coal, rock, waste material, and/or backfill material, among other examples). The machine 100 may receive the payload from a load location and transport the payload to a dump location (e.g., to be released at the dump location).

As further shown in FIG. 1, the machine 100 includes a controller 114 (e.g., an electronic control module (ECM), among other examples) that is communicatively coupled to one or more sensors 116 (e.g., one or more sensor devices of the machine 100 and/or the brake system of the machine 100). In some implementations, the controller 114 may include one or more memories (e.g., one or more non-transitory computer-readable mediums) and one or more processors communicatively coupled to the one or more memories. Communicative coupling between the one or more processors and the one or more memories may enable the one or more processors to read and/or process information stored in the one or more memories and/or to store information in the one or more memories.

In some implementations, the one or more memories may include one or more volatile and/or nonvolatile memories. For example, the one or more memories may include one or more random access memories (RAMs), read only memories (ROMs), hard disk drives, and/or other types of memories (e.g., flash memories, magnetic memories, and/or optical memories). The one or more memories may include one or more internal memories (e.g., one or more RAMs, ROMs, or hard disk drives) and/or one or more removable memories (e.g., removable via universal serial bus connections. The one or more memories may store information, one or more instructions, and/or software (e.g., one or more software applications) related to the operation of the controller 114.

The controller 114 may include an input component that enables the controller 114 to receive input, such as operator input and/or sensed input. For example, the input component may include a touch screen, a keyboard, a keypad, a mouse, a button, a microphone, a switch, a sensor, a global positioning system sensor, an accelerometer, a gyroscope, and/or an actuator.

The controller 114 may include an output component that enables the controller 114 to provide output, such as via a display, a speaker, and/or a light-emitting diode. The controller 114 may include a communication component that enables the controller 114 to communicate with other devices via a wired connection and/or a wireless connection. For example, the communication component may include a receiver, a transmitter, a transceiver, a modem, a network interface card, and/or an antenna.

The controller 114 may perform one or more operations or processes as described in more detail elsewhere herein. In some implementations, the controller 114 may include a non-transitory computer-readable medium (e.g., the one or more memories) that stores a set of instructions (e.g., one or more instructions or code) for execution by the one or more processors. The one or more processors may execute the set of instructions to perform one or more operations or processes described herein. In some implementations, execution of the set of instructions, by one or more processors, causes the one or more processors and/or the controller 114 to perform one or more operations or processes described herein. In some implementations, hardwired circuitry may be used instead of or in combination with the instructions to perform one or more operations or processes described herein. Thus, implementations described herein are not limited to any specific combination of hardware circuitry and software.

In some implementations, the one or more sensors 116 may be used (e.g., by the brake system) to monitor information associated with the machine 100 (e.g., stability data associated with the machine 100 and/or dynamic parameter information associated with the machine 100, among other examples). Accordingly, for example, the one or more sensors 116 may include one or more accelerometers (e.g., to measure linear accelerations associated with the machine 100), gyroscopes (e.g., to measure angular velocities and/or rotational rates associated with the machine 100), yaw rate sensors (e.g., to measure angular velocities associated with the machine 100), steering wheel angle sensors (e.g., to measure angles of a steering wheel of the machine 100), wheel speed sensors (e.g., to measure rotational speeds of wheels, or other traction devices of the machine 100), brake pressure sensors (e.g., to measure brake pressures associated with the reverse modulated brakes of the machine 100), suspension position sensors (e.g., to measure movement of suspension components of the machine 100), wheel pressure sensors (e.g., to measure air pressures of wheels, or other traction devices, of the machine 100), magnetometers (e.g., to measure orientations associated with the machine 100), lateral acceleration sensors (e.g., to measure lateral accelerations associated with the machine 100), roll angle sensors (e.g., to measure roll angles associated with the machine 100), pitch angle sensors (e.g., to measure pitch angles associated with the machine 100), wheel slip sensors (e.g., to measure differences between rotational speeds of the wheels of the machine 100 and/or speeds of the machine 100), and/or brake pedal sensors (e.g., to measure one or more brake pedal displacements of a brake pedal of the machine 100), among other examples.

In some implementations, the one or more sensors 116 may send, and the controller 114 may receive, the information associated with the machine 100 (e.g., the dynamic parameter information associated with the machine 100). The controller 114 may process the information associated with the machine 100, as described in more detail elsewhere herein.

In some implementations, the controller 114 may detect, based on the information associated with the machine 100, one or more stability events (e.g., associated with a stability of the machine 100). As an example, the controller 114 may detect an antilock brake system (ABS) event (e.g., associated with one or more wheels of the machine 100 locking up during a braking operation), a traction control system (TCS) event (e.g., associated with one or more wheels of the machine 100 losing traction during an acceleration operation), and/or a dynamic stability control (DSC) event (e.g., associated with reduced stability of the machine 100 during a maneuvering operation). As another example, the one or more stability events may be associated with at least one of a wheel slip event, a wheel skid event, an oversteer event, an understeer event, and/or a rollover prevention event.

In some implementations, the controller 114 may set, based on detecting the one or more stability events, an electronic stability braking control mode (e.g., an electrohydraulic braking control mode) to an active status. As an example, the electronic stability control mode may include an ABS mode (e.g., associated with preventing one or more wheels of the machine 100 from locking up during a braking operation), a TCS mode (e.g., associated with improving traction of one or more wheels of the machine 100 during an acceleration operation), and/or a DSC mode (e.g., associated with enhancing a stability of the machine 100 during a maneuvering operation). In some implementations, in the electronic stability braking control mode (e.g., when status of the electronic stability braking control mode is the active status), the controller 114 may determine a corrected brake pressure and/or may transmit one or more signals to adjust the brake pressure of a wheel of the machine 100, as described in more detail elsewhere herein.

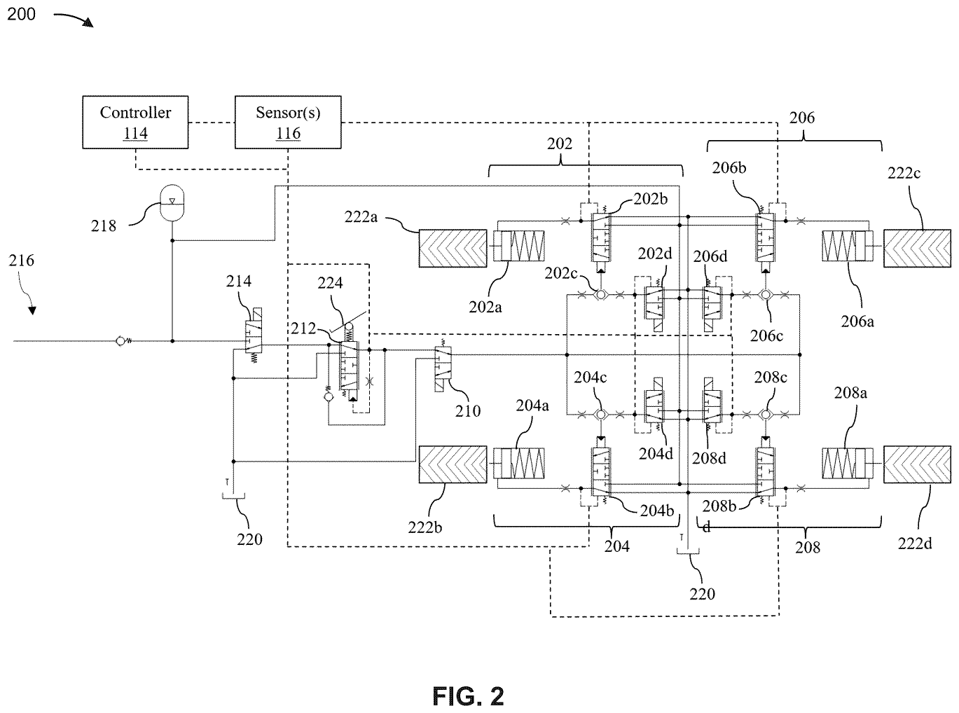

FIG. 2 is a diagram of an example brake system 200 with enhanced reverse modulated brake control. The term “reverse modulated brake control” is associated with the brake system 200 selectively and independently controlling reverse modulated brakes by increasing (e.g., to de-apply the reverse modulated brakes) or decreasing (e.g., to apply the reverse modulated brakes) a brake pressure that is supplied to, and received by, the reverse modulated brakes, as described in more detail elsewhere herein. For example, the brake system 200 may control, via reverse modulation of pressurized hydraulic fluid, one or more reverse modulated brakes that are operatively connected to one or more traction devices (e.g., one or more wheels, tracks, and/or rollers associated with the machine 100 of FIG. 1). As an example, the brake system 200 may control movement of a reverse modulated brake (e.g., that is operatively connected to a wheel of the machine 100 of FIG. 1) between a de-applied position (e.g., where the reverse modulated brake is not engaged with, and does not apply a brake force to, the wheel) and an applied position (e.g., where the reverse modulated brake is engaged with, and applies a brake force to, the wheel), as described in more detail elsewhere herein.

As shown in FIG. 2, the brake system 200 includes a controller 114, one or more sensors 116, a first reverse modulated brake circuit 202, a second reverse modulated brake circuit 204, a third reverse modulated brake circuit 206, a fourth reverse modulated brake circuit 208, a blocking valve 210, a hydro-mechanical valve 212, a park brake valve 214, a pressurized hydraulic fluid source 216, an accumulator 218, and a tank 220 (e.g., a fluid reservoir tank).

The first reverse modulated brake circuit 202 includes a first reverse modulated brake 202a, a first relay valve 202b, a first hydraulic logic element 202c (e.g., a first shuttle valve), and a first electrohydraulic valve 202d (e.g., a first electronic pressure reducing valve (ePRV)).

The first reverse modulated brake 202a is operatively connected to the first relay valve 202b. The first relay valve 202b is operatively connected to the first hydraulic logic element 202c. The first hydraulic logic element 202c is operatively connected to the first electrohydraulic valve 202d and the blocking valve 210.

The second reverse modulated brake circuit 204 includes a second reverse modulated brake 204a, a second relay valve 204b, a second hydraulic logic element 204c (e.g., a second shuttle valve), and a second electrohydraulic valve 204d (e.g., a second ePRV). The second reverse modulated brake 204a is operatively connected to the second relay valve 204b. The second relay valve 204b is operatively connected to the second hydraulic logic element 204c. The second hydraulic logic element 204c is operatively connected to the second electrohydraulic valve 204d and the blocking valve 210.

The third reverse modulated brake circuit 206 includes a third reverse modulated brake 206a, a third relay valve 206b, a third hydraulic logic element 206c (e.g., a third shuttle valve), and a third electrohydraulic valve 206d (e.g., a third ePRV). The third reverse modulated brake 206a is operatively connected to the third relay valve 206b. The third relay valve 206b is operatively connected to the third hydraulic logic element 206c. The third hydraulic logic element 206c is operatively connected to the third electrohydraulic valve 206d and the blocking valve 210.

The fourth reverse modulated brake circuit 208 includes a fourth reverse modulated brake 208a, a fourth relay valve 208b, a fourth hydraulic logic element 208c (e.g., a fourth shuttle valve), and a fourth electrohydraulic valve 208d (e.g., a fourth ePRV). The fourth reverse modulated brake 208a is operatively connected to the fourth relay valve 208b. The fourth relay valve 208b is operatively connected to the fourth hydraulic logic element 208c. The fourth hydraulic logic element 208c is operatively connected to the fourth electrohydraulic valve 208d and the blocking valve 210.

As further shown in FIG. 2, the blocking valve 210 is operatively connected to the hydro-mechanical valve 212 and to the tank 220. Accordingly, the blocking valve 210 is in fluid communication with the first reverse modulated brake circuit 202 (e.g., via the first hydraulic logic element 202c), the second reverse modulated brake circuit 204 (e.g., via the second hydraulic logic element 204c), the third reverse modulated brake circuit 206 (e.g., via the third hydraulic logic element 206c), the fourth reverse modulated brake circuit 208 (e.g., via the first hydraulic logic element 208c), the hydro-mechanical 212, and the tank 220, as described in more detail elsewhere herein.

The hydro-mechanical valve 212 is operatively connected to the park brake valve 214 and to the tank 220. The pressurized hydraulic fluid source 216 is operatively connected to the park brake valve 214 and the accumulator 218. The accumulator 218 is operatively connected to the first relay valve 202b, the second relay valve 204b, the third relay valve 206b, the fourth relay valve 208b, the first electrohydraulic valve 202d, the second electrohydraulic valve 204d, the third electrohydraulic valve 206d, and the fourth electrohydraulic valve 208d.

In some implementations, the pressurized hydraulic fluid source 216 charges the accumulator 218 (e.g., the accumulator 218 stores pressurized hydraulic fluid and potential energy that may be used by one or more components of the brake system 200). As an example, the pressurized hydraulic fluid and the potential energy, stored by the accumulator 218, may be used by the first relay valve 202a, the second relay valve 204a, the third relay valve 206a, the fourth relay valve 208a, the first electrohydraulic valve 202c, the second electrohydraulic valve 204c, the third electrohydraulic valve 206c, and the fourth electrohydraulic valve 208c, among other examples, as described in more detail elsewhere herein.

As further shown in FIG. 2, the first reverse modulated brake 202a is operatively connected to a first wheel 222a (e.g., a first wheel of the machine 100 of FIG. 1), the second reverse modulated brake 204a is operatively connected to a second wheel 222b (e.g., a second wheel of the machine 100 of FIG. 1), the third reverse modulated brake 206a is operatively connected to a third wheel 222c (e.g., a third wheel of the machine 100 of FIG. 1), and the fourth reverse modulated brake 208a is operatively connected to a fourth wheel 222d (e.g., a fourth wheel of the machine 100 of FIG. 1). In some implementations, the brake system 200 may selectively and independently control a brake torque associated with the first wheel 222a (e.g., by using the first reverse modulated brake circuit 202), the second wheel 222b (e.g., by using the second reverse modulated brake circuit 204), the third wheel 222c (e.g., by using the third reverse modulated brake circuit 206), and/or the fourth wheel 222d (e.g., by using the fourth reverse modulated brake circuit 208), as described in more detail elsewhere herein.

In some implementations, the brake system 200 may operate in a first mode, a second mode, and a third mode (e.g., to control the first reverse modulated brake 202a). For example, the brake system 200 may operate in the first mode to maintain the first reverse modulated brake 202a in a de-applied position, may operate in the second mode to cause the first reverse modulated brake 202a to move from the de-applied position to an applied position (e.g., based on a hydro-mechanical pressure signal), and/or may operate in the third mode to cause the first reverse modulated brake 202a to move from the de-applied position to an applied position (e.g., based on an electrohydraulic pressure signal), as described in more detail elsewhere herein.

In some implementations, when the brake system 200 operates in the first mode, the park brake valve 214 may be in a normally open position, the hydro-mechanical valve 212 may be in a normally open position, and the blocking valve 210 may be in a normally open position, which enables the pressurized hydraulic fluid source 216 to be in fluid communication with the first hydraulic logic element 202c (e.g., to a first inlet of the first hydraulic logic element 202c). The source of pressurized hydraulic fluid 216 may output, and the first hydraulic logic element 202c may receive, a de-apply pressure signal (or release pressure signal) (e.g., that indicates a de-apply pressure, or a release pressure, associated with pressurized hydraulic fluid provided by the source of pressurized hydraulic fluid 216).

The de-apply pressure signal may indicate a brake pressure associated with causing the first reverse modulated brake 202a to move to a de-applied position and/or maintaining the first reverse modulated brake 202a in the de-applied position. In some implementations, the de-applied position of the first reverse modulated brake 202a may be a fully released position where the first reverse modulated 202a does not apply a brake force to the first wheel 222a, as described in more detail elsewhere herein.

In some implementations, when the brake system 200 operates in the first mode, the first electrohydraulic valve 202d may be in fluid communication with a second inlet of the first hydraulic logic element 202c and may be in a de-energized state. In the de-energized state, the first electrohydraulic valve 202d does not output an electrohydraulic pressure (e.g., which results in the first hydraulic logic element 202c receiving pressure signal indicating a zero pressure). Accordingly, the first hydraulic logic element 206c enables the de-apply pressure signal to be received by the first relay valve 202b. The first relay valve 202b outputs, and the first reverse modulated brake 202a receives, a de-apply brake pressure based on the de-apply pressure signal, which causes the first reverse modulated brake 202a to move to the de-applied position (e.g., the fully released position). In this way, when the brake system operates in the first mode, the first reverse modulated brake 202a does not apply a brake force to the first wheel 222a. Although operation of the brake system 200 in the first mode to control the first reverse modulated brake 202a using the first reverse modulated brake circuit 202 is described herein, the brake system may operate, in the first mode, to control the second reverse modulated brake 204a using the second reverse modulated brake circuit 204, the third reverse modulated brake 206a using the third reverse modulated brake circuit 206, and the fourth reverse modulated brake 208a using the fourth reverse modulated brake circuit 208 in a same or similar manner and/or as described in more detail elsewhere herein.

In some implementations, the brake system 200 may operate in the second mode to cause the first reverse modulated brake 202a to move from the de-applied position to an applied position based on a hydro-mechanical pressure signal. In other words, the brake system 200 may operate in the second mode to apply a brake force (or brake torque) to the first wheel 222a based on a hydro-mechanical pressure signal (e.g., which is based on an operator input). As an example, the brake system 200 may transition from operating in the first mode to operating in the second mode based on an operator input. For example, an operator (not shown) may interact with an operator interface (e.g., shown as a brake pedal 224 in FIG. 2) that causes the hydro-mechanical valve 212 (e.g., a brake pedal valve) to move from the open position to a closed position based on the operator input. The hydro-mechanical valve 212 modulates the de-apply pressure to a hydro-mechanically modulated pressure based on the operator input (e.g., the brake pedal valve modulates lower pressure with increasing brake pedal 224 motion and based on the fluid connection between the hydro-mechanical valve 212 and the tank 220). The hydro-mechanical valve 212 outputs, and the first hydraulic logic element 202c receives, a hydro-mechanical pressure signal that is based on the operator input (e.g., that indicates the hydro-mechanically modulated pressure).

In some implementations, when the brake system 200 operates in the second mode, the first electrohydraulic valve 202d may be in a de-energized state where the first electrohydraulic valve 202d does not output an electrohydraulic pressure. Accordingly, the first hydraulic logic element 206c enables the hydro-mechanical pressure signal to be received by the first relay valve 202b. The first relay valve 202b outputs, and the first reverse modulated brake 202a receives, an apply pressure based on the hydro-mechanical pressure signal, which causes the first reverse modulated brake 202a to move from the de-applied position to the applied position (e.g., where the first reverse modulated brake 202a applies a brake force to the first wheel 222a based on the apply pressure). In this way, when the brake system operates in the second mode, the first reverse modulated brake 202a applies a brake force to the first wheel 222a. Although operation of the brake system 200 in the second mode to control the first reverse modulated brake 202a using the first reverse modulated brake circuit 202 is described herein, the brake system may operate, in the second mode, to control the second reverse modulated brake 204a using the second reverse modulated brake circuit 204, the third reverse modulated brake 206a using the third reverse modulated brake circuit 206, and the fourth reverse modulated brake 208a using the fourth reverse modulated brake circuit 208 in a same or similar manner and/or as described in more detail elsewhere herein.

In some implementations, the brake system 200 may operate in the third mode to cause the first reverse modulated brake 202a to move from the de-applied position to an applied position based on an electrohydraulic pressure signal. In other words, the brake system 200 may operate in the third mode to control a brake force (or brake torque) that is applied to the first wheel 222a based on the electrohydraulic pressure signal.

In some implementations, the one or more sensors 116 (e.g., one or more sensor devices of the machine of FIG. 1) may send, and the controller 114 may receive, stability data associated with the first wheel 222a, the second wheel 222b, the third wheel 222c, and/or the fourth wheel 222d. As an example, the one or more sensors 116 may send, and the controller 114 may receive, stability data associated with the first wheel 222a, the second wheel 222b, the third wheel 222c, and/or the fourth wheel 222d. The controller 114 may detect, based on the stability data, a stability event associated with the first wheel 222a, the second wheel 222b, the third wheel 222c, and/or the fourth wheel 222d.

In some implementations, the controller 114 may set, based on detecting the stability event, an electronic stability control braking mode (e.g., an automatic electrohydraulic braking mode) to an active status. The controller 114 may cause, based on the active status, the blocking valve 210 to move to the closed position. For example, the controller 114 may send, and the blocking valve 210 may receive, a control signal (e.g., a blocking signal) that actuates the blocking valve 210 to move from the open position to a closed position. In closing the blocking valve 210, the pressurized fluid from the hydro-mechanical valve 212 is blocked and isolated from the first hydraulic logic element 202c (e.g., the first inlet of the first hydraulic logic element 202c does not receive the pressurized fluid from the hydro-mechanical valve 212) and the blocking valve 210 enables the first hydraulic logic element 202c to be in fluid communication with the tank 220 (e.g., the first inlet of the first hydraulic logic element 202c is in fluid communication with the tank 220). In other words, when the blocking valve 210 is in the closed position, the hydro-mechanical valve 212 is not in fluid communication with the first hydraulic logic element 202c and the first hydraulic logic element 202c is in fluid communication with the tank 220. In this way, the blocking valve 210 prevents the first hydraulic logic element 206c from receiving pressurized hydraulic fluid from the hydro-mechanical valve 212.

In some implementations, the controller 114 may determine a corrected apply pressure based on the stability event. The controller 114 may cause the first electrohydraulic valve 202d to output the electrohydraulic pressure signal based on the corrected apply pressure, which is received by the first hydraulic logic element 202c. The first hydraulic logic element 206c enables the electrohydraulic pressure signal to be received by the first relay valve 202b (e.g., because a pressure indicated by the electrohydraulic valve 202d is a higher pressure than a pressure indicated by the hydro-mechanical pressure signal). The first relay valve 202b outputs, and the first reverse modulated brake 202a receives, an apply pressure based on the electrohydraulic pressure signal, which causes the first reverse modulated brake 202a to move from a first applied position to a second applied position (e.g., where the first reverse modulated brake 202a applies a brake force to the first wheel 222a based on the apply pressure). Accordingly, in some implementations, the first hydraulic logic element 202c may include a first inlet, in fluid communication with the blocking valve 210, for receiving a hydro-mechanical pressure signal, a second inlet, in fluid communication with the first electrohydraulic valve 202d electrohydraulic valve, for receiving the electrohydraulic pressure signal, and an outlet, in fluid communication with the first relay valve 202b, for outputting a higher-pressure signal of the hydro-mechanical pressure signal and the electrohydraulic pressure signal as described in more detail elsewhere herein.

In this way, when the brake system 200 operates in the third mode, the first reverse modulated brake 202a applies a brake force to the first wheel 222a. Although operation of the brake system 200 in the third mode to control the first reverse modulated brake 202a using the first reverse modulated brake circuit 202 is described herein, the brake system may operate, in the third mode, to control the second reverse modulated brake 204a using the second reverse modulated brake circuit 204, the third reverse modulated brake 206a using the third reverse modulated brake circuit 206, and the fourth reverse modulated brake 208a using the fourth reverse modulated brake circuit 208 in a same or similar manner and/or as described in more detail elsewhere herein.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

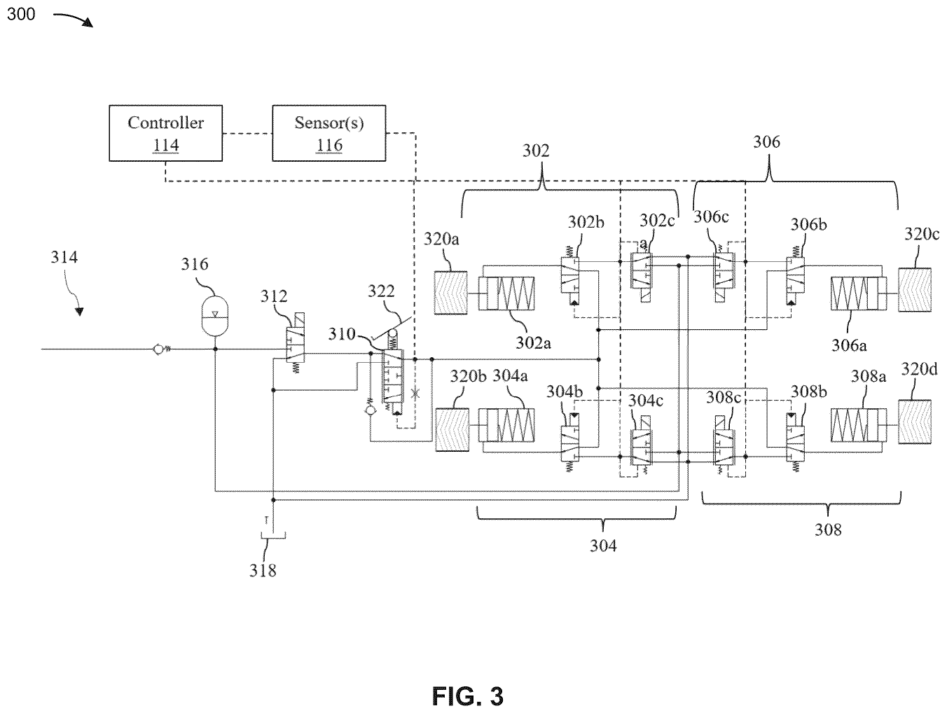

FIG. 3 is a diagram of an example brake system 300 with enhanced reverse modulated brake control. As shown in FIG. 3 the brake system 300 includes a controller 114, one or more sensors 116, a first reverse modulated brake circuit 302, a second reverse modulated brake circuit 304, a third reverse modulated brake circuit 306, a fourth reverse modulated brake circuit 308, a hydro-mechanical valve 310, a park brake valve 312, a pressurized hydraulic fluid source 314, an accumulator 316, and a tank 318.

The first reverse modulated brake circuit 302 includes a first reverse modulated brake 302a, a first selector valve 302b, and a first electrohydraulic valve 302c (e.g., a first ePRV). The first reverse modulated brake 302a is operatively connected to the first selector valve 302b.

The first selector valve 302b is operably connected to the first electrohydraulic valve 302c and the hydro-mechanical valve 310.

The second reverse modulated brake circuit 304 includes a second reverse modulated brake 304a, a second selector valve 304b, and a second electrohydraulic valve 304c (e.g., a second ePRV). The second reverse modulated brake 304a is operatively connected to the second selector valve 304b. The second selector valve 304b is operably connected to the second electrohydraulic valve 304c and the hydro-mechanical valve 310.

The third reverse modulated brake circuit 306 includes a third reverse modulated brake 306a, a third selector valve 306b, and a third electrohydraulic valve 306c (e.g., a third ePRV). The third reverse modulated brake 306a is operatively connected to the third selector valve 306b. The third selector valve 306b is operably connected to the third electrohydraulic valve 306c and the hydro-mechanical valve 310.

The fourth reverse modulated brake circuit 308 includes a fourth reverse modulated brake 308a, a fourth selector valve 308b, and a fourth electrohydraulic valve 308c (e.g., a fourth ePRV). The fourth reverse modulated brake 308a is operatively connected to the fourth selector valve 308b. The fourth selector valve 308b is operably connected to the fourth electrohydraulic valve 308c and the hydro-mechanical valve 310. Accordingly, the hydro-mechanical valve 310 is in fluid communication with the first reverse modulated brake circuit 302 (e.g., via the first selector valve 302b), the second reverse modulated brake circuit 304 (e.g., via the second selector valve 304b), the third reverse modulated brake circuit 306 (e.g., via the third selector valve 306b), and the fourth reverse modulated brake circuit 308 (e.g., via the fourth selector valve 308b.

The hydro-mechanical valve 310 is operatively connected to the park brake valve 312 and to the tank 318. The pressurized hydraulic fluid source 314 is operatively connected to the park brake valve 312 and the accumulator 316. The accumulator 316 is operatively connected to the first electrohydraulic valve 302c, the second electrohydraulic valve 304c, the third electrohydraulic valve 306c, and the fourth electrohydraulic valve 308c. In some implementations, the pressurized hydraulic fluid source 314 charges the accumulator 316 (e.g., the accumulator 316 stores pressurized hydraulic fluid and potential energy that may be used by one or more components of the brake system 300). As an example, the pressurized hydraulic fluid and the potential energy, stored by the accumulator 316, may be used by the first electrohydraulic valve 302c, the second electrohydraulic valve 304c, the third electrohydraulic valve 306c, and the fourth electrohydraulic valve 308c, among other examples, as described in more detail elsewhere herein.

As further shown in FIG. 3, the first reverse modulated brake 302a is operatively connected to a first wheel 320a (e.g., a first wheel of the machine 100 of FIG. 1), the second reverse modulated brake 304a is operatively connected to a second wheel 320b (e.g., a second wheel of the machine 100 of FIG. 1), the third reverse modulated brake 306a is operatively connected to a third wheel 320c (e.g., a third wheel of the machine 100 of FIG. 1), and the fourth reverse modulated brake 308a is operatively connected to a fourth wheel 320d (e.g., a fourth wheel of the machine 100 of FIG. 1). In some implementations, the brake system 300 may selectively and independently control a brake torque associated with the first wheel 320a (e.g., by using the first reverse modulated brake circuit 302), the second wheel 320b (e.g., by using the second reverse modulated brake circuit 304), the third wheel 320c (e.g., by using the third reverse modulated brake circuit 306), and/or the fourth wheel 320d (e.g., by using the fourth reverse modulated brake circuit 308), as described in more detail elsewhere herein.

In some implementations, the brake system 300 may operate in a first mode, a second mode, and a third mode to control the first reverse modulated brake 302a. For example, the brake system 300 may operate in the first mode to maintain the first reverse modulated brake 302a in a de-applied position, may operate in the second mode to cause the first reverse modulated brake 302a to move from the de-applied position to an applied position based on a hydro-mechanical pressure signal, and/or may operate in the third mode to cause the first reverse modulated brake 302a to move from the de-applied position to an applied position based on an electrohydraulic pressure signal.

In some implementations, the first selector valve 302b is movable between a first position and a second position. When the first selector valve 302b is in the first position, the first selector valve 302b enables the first reverse modulated brake 302a to be in fluid communication with the hydro-mechanical valve 310. When the first selector valve 302b is in the second position, the first selector valve 302b enables the first reverse modulated brake 302a to be in fluid communication with the first electrohydraulic valve 302c.

In some implementations, when the brake system 300 operates in the first mode, the park brake valve 312 may be in a normally open position, the hydro-mechanical valve 310 (e.g., the brake pedal valve) may be in a normally open position, and the first selector valve 302b may be in the first position, which enables the accumulator 314 to be in fluid communication with the first reverse modulated brake 302a. Accordingly, for example, the accumulator 314 may output a de-apply pressure signal (e.g., in similar or same manner as the accumulator 218 outputs a de-apply pressure signal, as described in connection with FIG. 2 and/or as described in more detail elsewhere herein) that flows through the park brake valve 312, through the hydro-mechanical valve 310, and through the first selector valve 302b to be received by the first reverse modulated brake 302a. The first reverse modulated brake 302a receives a de-apply brake pressure based on the de-apply pressure signal, which causes the first reverse modulated brake 302a to move to the de-applied position (e.g., the fully released position). In this way, when the brake system 300 operates in the first mode, the first reverse modulated brake 302a does not apply a brake force to the first wheel 320a. Although operation of the brake system 300 in the first mode to control the first reverse modulated brake 302a using the first reverse modulated brake circuit 302 is described herein, the brake system 300 may operate, in the first mode, to control the second reverse modulated brake 304a using the second reverse modulated brake circuit 304, the third reverse modulated brake 306a using the third reverse modulated brake circuit 306, and the fourth reverse modulated brake 308a using the fourth reverse modulated brake circuit 308 in a same or similar manner and/or as described in more detail elsewhere herein.

In some implementations, the brake system 300 may operate in the second mode to cause the first reverse modulated brake 302a to move from the de-applied position to an applied position based on a hydro-mechanical pressure signal. In other words, the brake system 300 may operate in the second mode to apply a brake force (or brake torque) to the first wheel 320a based on a hydro-mechanical pressure signal (e.g., which is based on an operator input). As an example, the brake system 300 may transition from operating in the first mode to operating in the second mode based on an operator input. For example, an operator (not shown) may interact with an operator interface (e.g., shown as a brake pedal 322 in FIG. 3) that causes the hydro-mechanical valve 310 (e.g., the brake pedal valve) to move from the open position to a closed position based on the operator input. The hydro-mechanical valve 310 modulates the de-apply pressure to a hydro-mechanically modulated pressure based on the operator input (e.g., the brake pedal valve modulates lower pressure with increasing brake pedal 322 motion and based on the fluid connection between the hydro-mechanical valve 310 and the tank 318). The hydro-mechanical valve 310 outputs a hydro-mechanical pressure signal that flows through the first selector valve 302b (e.g., to be received by the first reverse modulated brake assembly 302a) based on the operator input (e.g., that indicates the hydro-mechanically modulated pressure).

The first reverse modulated brake 302a receives an apply pressure based on the hydro-mechanical pressure signal, which causes the first reverse modulated brake 302a to move from the de-applied position to the applied position (e.g., where the first reverse modulated brake 302a applies a brake force to the first wheel 320a based on the apply pressure). In this way, when the brake system 300 operates in the second mode, the first reverse modulated brake 302a applies a brake force to the first wheel 320a. Although operation of the brake system 300 in the second mode to control the first reverse modulated brake 302a using the first reverse modulated brake circuit 302 is described herein, the brake system 300 may operate, in the second mode, to control the second reverse modulated brake 304a using the second reverse modulated brake circuit 304, the third reverse modulated brake 306a using the third reverse modulated brake circuit 306, and the fourth reverse modulated brake 308a using the fourth reverse modulated brake circuit 308 in a same or similar manner and/or as described in more detail elsewhere herein.

In some implementations, the brake system 300 may operate in the third mode to cause the first reverse modulated brake 302a to move from the de-applied position to an applied position based on an electrohydraulic pressure signal. In other words, the brake system 300 may operate in the third mode to control a brake force (or brake torque) that is applied to the first wheel 320a based on the electrohydraulic pressure signal.

In some implementations, the controller 114 may set, based on detecting the stability event, an electronic stability control braking mode to an active status, as described in more detail elsewhere herein. The controller 114 may send, and the first electrohydraulic valve 302c may receive, a brake apply command (e.g., an electrohydraulic brake apply command) based on the active status. The first electrohydraulic valve 302c may output a brake pressure based on the brake apply command, which causes the first selector valve 302b to move (e.g., shift) to the second position. As an example, the first selector valve 302b, when in the second position, prevents the hydro-mechanical valve 310 from being in fluid communication with the first reverse modulated brake 302a and enables the first electrohydraulic valve 302c to be in fluid communication with the first reverse modulated brake 302a (e.g., which enables the electrohydraulic brake apply command to override a brake apply command that is based on an operator input). In this way, the first selector valve 302b prevents the first reverse modulated brake 302a from receiving pressurized hydraulic fluid from the hydro-mechanical valve 310 and enables the first reverse modulated brake 302a to receive pressurized hydraulic fluid from the first electrohydraulic valve 302c. Accordingly, in some implementations, electrohydraulic brake apply commands will override brake apply commands that are based on operator inputs.

In some implementations, the controller 114 may determine a corrected apply pressure based on the stability event, as described in more detail elsewhere herein. The first electrohydraulic valve 302c outputs, and the first reverse modulated brake 302a receives, an apply pressure (e.g., based on the electrohydraulic pressure signal), which causes the first reverse modulated brake 302a to move from a first applied position to a second applied position (e.g., where the first reverse modulated brake 302a applies a brake force to the first wheel 320a based on the apply pressure). In this way, when the brake system 300 operates in the third mode, the first reverse modulated brake 302a applies a brake force to the first wheel 320a. Although operation of the brake system 300 in the third mode to control the first reverse modulated brake 302a using the first reverse modulated brake circuit 302 is described herein, the brake system 300 may operate, in the third mode, to control the second reverse modulated brake 304a using the second reverse modulated brake circuit 304, the third reverse modulated brake 306a using the third reverse modulated brake circuit 306, and the fourth reverse modulated brake 308a using the fourth reverse modulated brake circuit 308 in a same or similar manner and/or as described in more detail elsewhere herein.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

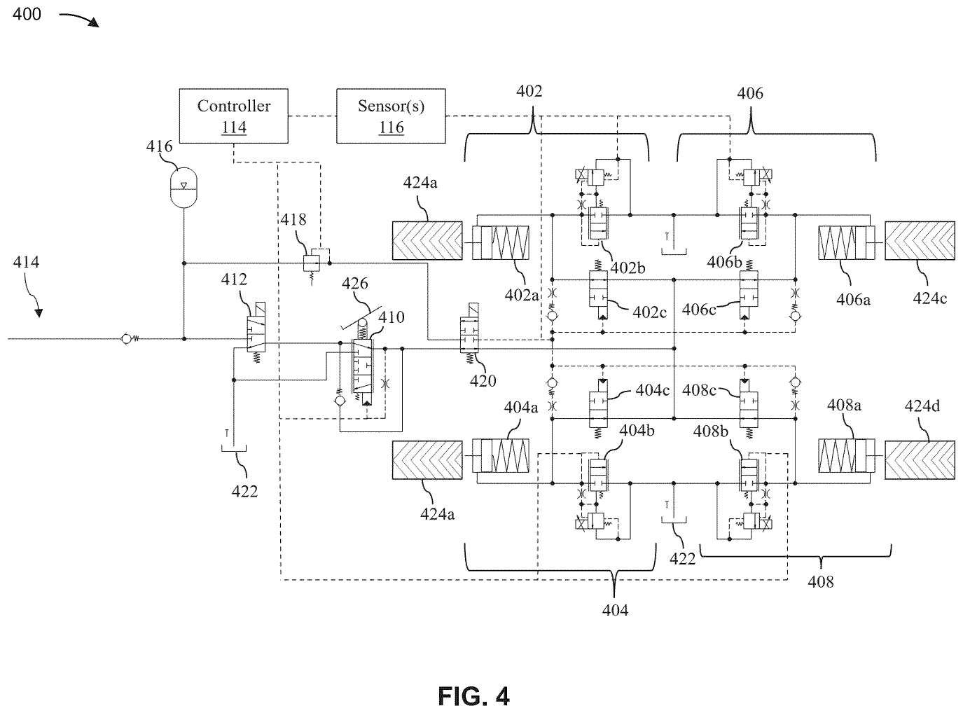

FIG. 4 is a diagram of an example brake system 400 with enhanced reverse modulated brake control. As shown in FIG. 4 the brake system 400 includes a controller 114, one or more sensors 116, a first reverse modulated brake circuit 402, a second reverse modulated brake circuit 404, a third reverse modulated brake circuit 406, a fourth reverse modulated brake circuit 408, a hydro-mechanical valve 410, a park brake valve 412, a pressurized hydraulic fluid source 414, an accumulator 416, a pressure reducing valve 418, a blocking valve 420, and a tank 422.

The first reverse modulated brake circuit 402 includes a first reverse modulated brake 402a, a first electrohydraulic relief valve 402b (e.g., a first electronic relief valve (eRV)), and a first isolating valve 402c. The first reverse modulated brake 402a is operatively connected to the first electrohydraulic relief valve 402b, the first isolating valve 402c, and the blocking valve 420. The first isolating valve 402c is operatively connected to the hydro-mechanical valve 410 and the blocking valve 420.

The second reverse modulated brake circuit 404 includes a second reverse modulated brake 404a, a second electrohydraulic relief valve 404b (e.g., a second eRV), and a second isolating valve 404c. The second reverse modulated brake 404a is operatively connected to the second electrohydraulic relief valve 404b, the second isolating valve 404c, and the blocking valve 420. The second isolating valve 404c is operatively connected to the hydro-mechanical valve 410 and the blocking valve 420.

The third reverse modulated brake circuit 406 includes a third reverse modulated brake 406a, a third electrohydraulic relief valve 406b (e.g., a third eRV), and a third isolating valve 406c. The third reverse modulated brake 406a is operatively connected to the third electrohydraulic relief valve 406b, the third isolating valve 406c, and the blocking valve 420. The third isolating valve 406c is operatively connected to the hydro-mechanical valve 410 and the blocking valve 420.

The fourth reverse modulated brake circuit 408 includes a fourth reverse modulated brake 408a, a fourth electrohydraulic relief valve 408b (e.g., a fourth eRV), and a fourth isolating valve 408c. The fourth reverse modulated brake 408a is operatively connected to the fourth electrohydraulic relief valve 408b, the fourth isolating valve 408c, and the blocking valve 420. The fourth isolating valve 408c is operatively connected to the hydro-mechanical valve 410 and the blocking valve 420.

Accordingly, the hydro-mechanical valve 410 is in fluid communication with the first reverse modulated brake circuit 402 (e.g., via the first isolating valve 402c), the second reverse modulated brake circuit 404 (e.g., via the second isolating valve 404c), the third reverse modulated brake circuit 406 (e.g., via the third isolating valve 406c), and the fourth reverse modulated brake circuit 408 (e.g., via the fourth isolating valve 408c).

The hydro-mechanical valve 410 is operatively connected to the park brake valve 412. The pressurized hydraulic fluid source 414 is operatively connected to the park brake valve 412 and the accumulator 416. In some implementations, the pressurized hydraulic fluid source 414 charges the accumulator 416 (e.g., the accumulator 416 stores pressurized hydraulic fluid and potential energy that may be used by one or more components of the brake system 400). The accumulator 416 is operatively connected to the pressure reducing valve 418. The pressure reducing valve 418 is operatively connected to the blocking valve 420. Accordingly, pressurized hydraulic fluid provided from the accumulator may flow through the pressure reducing valve 418, which enables the pressure reducing valve 418 to regulate a pressure of the pressurized hydraulic fluid that is received by the blocking valve 420.

In some implementations, the pressurized hydraulic fluid and the potential energy, stored by the accumulator 416, may be used by, the first electrohydraulic relief valve 402b, the second electrohydraulic relief valve 404b, the third electrohydraulic relief valve 406b, the fourth electrohydraulic relief valve 408b, and/or the blocking valve 420, among other examples, as described in more detail elsewhere herein.

As further shown in FIG. 4, the first reverse modulated brake 402a is operatively connected to a first wheel 424a (e.g., a first wheel of the machine 100 of FIG. 1), the second reverse modulated brake 404a is operatively connected to a second wheel 424b (e.g., a second wheel of the machine 100 of FIG. 1), the third reverse modulated brake 406a is operatively connected to a third wheel 424c (e.g., a third wheel of the machine 100 of FIG. 1), and the fourth reverse modulated brake 408a is operatively connected to a fourth wheel 424d (e.g., a fourth wheel of the machine 100 of FIG. 1). In some implementations, the brake system 400 may selectively and independently control a brake torque associated with the first wheel 424a (e.g., by using the first reverse modulated brake circuit 402), the second wheel 424b (e.g., by using the second reverse modulated brake circuit 404), the third wheel 424c (e.g., by using the third reverse modulated brake circuit 406), and/or the fourth wheel 424d (e.g., by using the fourth reverse modulated brake circuit 408), as described in more detail elsewhere herein.

In some implementations, the brake system 400 may operate in a first mode, a second mode, and a third mode to control the first reverse modulated brake 402a. For example, the brake system 400 may operate in the first mode to maintain the first reverse modulated brake 402a in a de-applied position, may operate in the second mode to cause the first reverse modulated brake 402a to move from the de-applied position to an applied position based on a hydro-mechanical pressure signal, and/or may operate in the third mode to cause the first reverse modulated brake 402a to move from the de-applied position to an applied position based on an electrohydraulic pressure signal.

In some implementations, the first isolating valve 402c may be movable between a first position and a second position and the blocking valve 420 may be movable between an open position and a closed position. When the first isolating valve 402c is in the first position and the blocking valve 420 is in the closed position, the first reverse modulated brake 402a may be in fluid communication with the hydro-mechanical valve 410. When the first isolating valve 402c is in the second position and the blocking valve 420 is in the open position, the first reverse modulated brake 402a is in fluid communication with the pressure reducing valve 418 and the first electrohydraulic relief valve 402b.

Accordingly, for example, the pressurized hydraulic fluid source 414 may output a de-apply pressure signal that flows through the park brake valve 412, through the hydro-mechanical valve 410, and through the first isolating valve 402c to be received by the first reverse modulated brake 402a. The first reverse modulated brake 402a receives a de-apply brake pressure based on the de-apply pressure signal, which causes the first reverse modulated brake 402a to move to the de-applied position (e.g., the fully released position). In this way, when the brake system 400 operates in the first mode, the first reverse modulated brake 402a does not apply a brake force to the first wheel 424a. Although operation of the brake system 400 in the first mode to control the first reverse modulated brake 402a using the first reverse modulated brake circuit 402 is described herein, the brake system 400 may operate, in the first mode, to control the second reverse modulated brake 404a using the second reverse modulated brake circuit 404, the third reverse modulated brake 406a using the third reverse modulated brake circuit 406, and the fourth reverse modulated brake 408a using the fourth reverse modulated brake circuit 408 in a same or similar manner and/or as described in more detail elsewhere herein.

In some implementations, the brake system 400 may operate in the second mode to cause the first reverse modulated brake 402a to move from the de-applied position to an applied position based on a hydro-mechanical pressure signal. In other words, the brake system 400 may operate in the second mode to apply a brake force (or brake torque) to the first wheel 424a based on a hydro-mechanical pressure signal. As an example, the brake system 400 may transition from operating in the first mode to operating in the second mode based on an operator input. For example, an operator (not shown) may interact with an operator interface (e.g., shown as a brake pedal 426 in FIG. 4) that causes the hydro-mechanical valve 410 (e.g., a brake pedal valve) to move from the open position to a closed position based on the operator input. The hydro-mechanical valve 410 modulates the de-apply pressure to a hydro-mechanically modulated pressure based on the operator input (e.g., the brake pedal valve modulates lower pressure with increasing brake pedal 426 motion and based on the fluid connection between the hydro-mechanical valve 410 and the tank 422). The hydro-mechanical valve 410 outputs a hydro-mechanical pressure signal that is based on the operator input (e.g., that indicates the hydro-mechanically modulated pressure).

The hydro-mechanical pressure signal flows through the first isolating valve 402c and is received by the first reverse modulated brake 402a, which causes the first reverse modulated brake 402a to move from the de-applied position to the applied position (e.g., where the first reverse modulated brake 402a applies a brake force to the first wheel 424a based on the apply pressure). In this way, when the brake system 400 operates in the second mode, the first reverse modulated brake 402a applies a brake force to the first wheel 424a. Although operation of the brake system 400 in the second mode to control the first reverse modulated brake 402a using the first reverse modulated brake circuit 402 is described herein, the brake system 400 may operate, in the second mode, to control the second reverse modulated brake 404a using the second reverse modulated brake circuit 404, the third reverse modulated brake 406a using the third reverse modulated brake circuit 406, and the fourth reverse modulated brake 408a using the fourth reverse modulated brake circuit 408 in a same or similar manner and/or as described in more detail elsewhere herein.

In some implementations, the brake system 400 may operate in the third mode to cause the first reverse modulated brake 402a to move from the de-applied position to an applied position based on an electrohydraulic pressure signal. In other words, the brake system 400 may operate in the third mode to control a brake force (or brake torque) that is applied to the first wheel 424a based on the electrohydraulic pressure signal (e.g., which is based on an electrohydraulic input).

In some implementations, the controller 114 may set, based on detecting the stability event, an electronic stability control braking mode to an active status, as described in more detail elsewhere herein. The controller 114 may cause, based on the active status, the first electrohydraulic relief valve 402b to maintain an electrohydraulic pressure, which is supplied by pressurized hydraulic fluid provided by the accumulator 416 (e.g., through the pressure reducing valve 418 and the blocking valve 420).

In some implementations, the controller 114 may cause the first electrohydraulic relief valve 402b to maintain an electrohydraulic pressure signal. For example, the controller 114 may send, and the first electrohydraulic relief valve 402b may receive, a control signal that causes the first electrohydraulic relief valve 402b to maintain the electrohydraulic pressure signal.

In some implementations, the controller 114 may cause the blocking valve 420 to move from the closed position to the open position. For example, the controller 114 may send, and the blocking valve 420 may receive, a control signal that causes the blocking valve 420 to move from the open position to the closed position, which prevents the hydro-mechanical valve 410 from being in fluid communication with the first isolating valve 402c.

In some implementations, the controller 114 may cause the first isolating valve 402c to move from the first position to the second position. For example, the controller 114 may send, and the blocking valve 420 may receive, a control signal that causes the blocking valve 420 to move (e.g., shift) to the closed position. The blocking valve 420, when in the closed position, prevents the hydro-mechanical valve 410 from sending pressure signals (e.g., based on operator inputs) to the first reverse modulated brake 402a. Furthermore, when the blocking valve 420 is in the closed position, the pressure reducing valve 418 is operatively connected to the first isolating valve 402c (e.g., the pressure reducing valve 418 is in fluid communication with the first isolating valve 402c). The first isolating valve 402c moves (e.g., shifts) to the closed position in response to receiving pressure from the pressure reducing valve 418.

The first isolating valve 402c, when in the closed position, prevents the hydro-mechanical valve 410 from sending pressure signals (e.g., based on operator inputs) to the first reverse modulated brake 402a and prevents the reverse modulated brake 402a from receiving pressure signals from the second reverse modulated brake circuit 404, the third reverse modulated brake circuit 406, and the fourth reverse modulated brake circuit 408 (e.g., because pressures associated with each of the first reverse modulated brake circuit 402, the second reverse modulated brake circuit 404, the third reverse modulated brake circuit 406, and/or the fourth reverse modulated brake circuit 408 may be associated with different pressures).

In other words, for example, the first isolating valve 402c prevents the first reverse modulated brake 402a from being in fluid communication with the hydro-mechanical valve 410 and enables the first reverse modulated brake 402a to be in fluid communication with the blocking valve 420 and the first electrohydraulic relief valve 402b. In this way, the blocking valve 420 provides pressurized hydraulic fluid at a pressure based on the electrohydraulic signal that is maintained by the first electrohydraulic valve (e.g., the first electrohydraulic relief valve 402b drains off excess pressure as pressurized hydraulic fluid flows from the blocking valve 420 to the first reverse modulated brake 402a).

This enables the hydro-mechanical pressure signal to be blocked and the electrohydraulic pressure to be received by the first reverse modulated brake 402a. The first reverse modulated brake 402a receives, an apply pressure (e.g., based on the electrohydraulic pressure signal), which causes the first reverse modulated brake 402a to move from a first de-applied position to a second applied position (e.g., where the first reverse modulated brake 402a applies a brake force to the first wheel 424a based on the apply pressure). In this way, when the brake system 400 operates in the third mode, the first reverse modulated brake 402a applies a brake force to the first wheel 424a. Although operation of the brake system 400 in the third mode to control the first reverse modulated brake 402a using the first reverse modulated brake circuit 402 is described herein, the brake system 400 may operate, in the third mode, to control the second reverse modulated brake 404a using the second reverse modulated brake circuit 404, the third reverse modulated brake 406a using the third reverse modulated brake circuit 406, and the fourth reverse modulated brake 408a using the fourth reverse modulated brake circuit 408 in a same or similar manner and/or as described in more detail elsewhere herein.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

### INDUSTRIAL APPLICABILITY

As noted above, the disclosed subject matter relates to a brake system having enhanced reverse modulated brake control. The brake system may be used with any machine, such as a UAT. Generally, the brake system may be used to control reverse modulated brakes between a de-applied position and an applied position. The brake system may provide, and the reverse modulated brakes may receive, a brake pressure that is based on at least one of a hydro-mechanical pressure signal or an electrohydraulic pressure signal, as described in more detail elsewhere herein. Thus, for example, the brake system may selectively and independently control a brake pressure that is supplied to the reverse modulated brakes. As an example, the brake system may prevent the hydro-mechanical pressure signal from controlling the brake pressure that is supplied to the reverse modulated brakes and may enable the electrohydraulic pressure signal to control the brake pressure that is supplied to the reverse modulated brakes.

Accordingly, in some implementations, the brake system may include a reverse modulated brake (e.g., that is operatively connected to a wheel of the machine), a relay valve, in fluid communication with the reverse modulated brake, for supplying, to the reverse modulated brake, at least one of a de-apply pressure that causes the reverse modulated brake to be in a de-applied position or an apply pressure that causes the reverse modulated brake to be in an applied position. The apply pressure may be based on at least one of a hydro-mechanical pressure signal or an electrohydraulic pressure signal. As an example, the apply pressure may be lower than the de-apply pressure. The brake system may further include a hydro-mechanical valve, in fluid communication with the relay valve, for outputting the hydro-mechanical pressure signal, and an electrohydraulic valve, in fluid communication with the relay valve, for outputting the electrohydraulic pressure signal. The brake system may further include a blocking valve, in fluid communication with the relay valve and the hydro-mechanical valve, that is movable between a closed position and an open position. The blocking valve may enable the hydro-mechanical valve to be in fluid communication with the relay valve when the blocking valve is in the open position and may prevent the hydro-mechanical valve from being in fluid communication with the relay valve when the blocking valve is in the closed position.

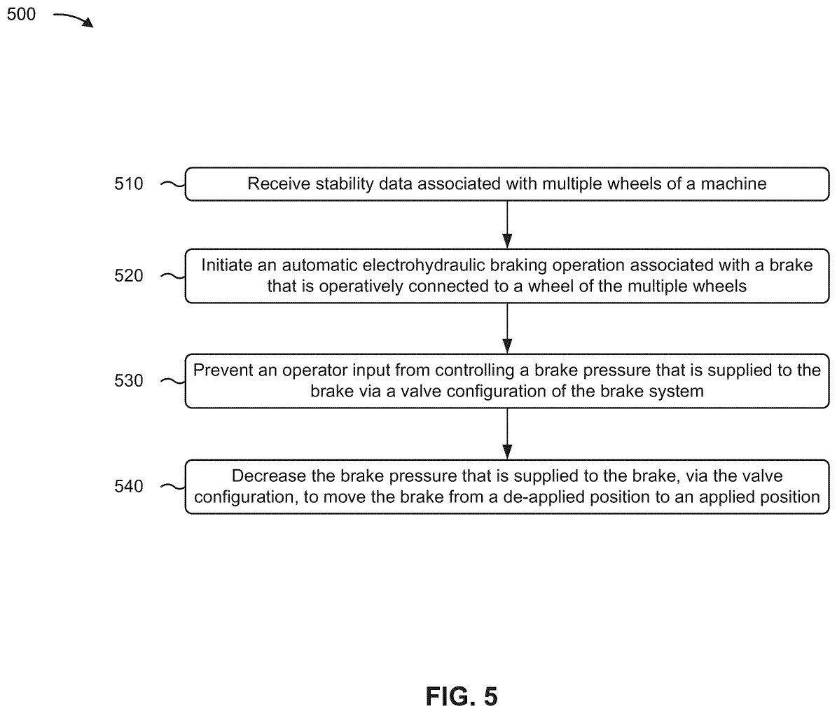

FIG. 5 is a flowchart of an example process 500 associated with enhanced reverse modulated brake control. In some implementations, one or more process blocks of FIG. 5 may be performed by a brake system (e.g., the brake system 200, the brake system 300, and/or the brake system 400). In some implementations, one or more process blocks of FIG. 5 may be performed by another device or a group of devices separate from or including the brake system, such as a controller (e.g., the controller 114).

As shown in FIG. 5, process 500 may include receiving stability data associated with multiple wheels of the machine (block 510). For example, the brake system may receive stability data associated with multiple wheels of the machine, as described above. In some implementations, the stability data may be associated with at least one of a wheel slip event, a wheel skid event, an oversteer event, an understeer event, and/or a rollover prevention event.

As further shown in FIG. 5, process 500 may include initiating, based on the stability data, an automatic electrohydraulic braking operation associated with a brake that is operatively connected to a wheel, of the multiple wheels (block 520). For example, the brake system may initiate, based on the stability data, the automatic electrohydraulic braking operation associated with the brake that is operatively connected to the wheel, as described above. In some implementations, the brake is movable from a de-applied position to an applied position to apply a brake force to the wheel. In some implementations, the automatic electrohydraulic braking operation is associated with at least one of an antilock brake system, a traction control system, and/or a dynamic stability control system.

As further shown in FIG. 5, process 500 may include preventing, based on initiating the automatic electrohydraulic braking operation, an operator input from controlling a brake pressure that is supplied to the brake via a valve configuration of the brake system (block 530) (e.g., a valve configuration of the brake system 200, the brake system 300, and/or the brake system 400). For example, the brake system may prevent, based on initiating the automatic electrohydraulic braking operation, the operator input from controlling a brake pressure that is supplied to the brake via the valve configuration (e.g., associated with the brake system 200, the brake system 300, and/or the brake system 400), as described above. In some implementations, preventing, by the brake system, the operator input from controlling the brake pressure that is supplied to the brake, via the valve configuration, comprises closing, by the brake system, a blocking valve that causes a pressure associated with the operator input to be lower than a pressure associated with the electrohydraulic pressure signal.

As further shown in FIG. 5, process 500 may include decreasing, the brake pressure that is supplied to the brake, via the valve configuration, to move the brake from the de-applied position to the applied position to apply the brake force to the wheel (block 540). For example, the brake system may decrease the brake pressure that is supplied to the brake, via the valve configuration, to move the brake from the de-applied position to the applied position to apply the brake force to the wheel, as described above. In some implementations, the brake force is provided via a mechanical spring of the brake. In some implementations, the process 500 further includes stopping the automatic electrohydraulic brake operation and enabling the operator input to control the brake pressure that is supplied to the brake via the valve configuration.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

In this way, because the brake system may selectively and independently control reverse modulated brakes of a machine, the brake system may provide electrohydraulic braking operations that require independent control of the brake force that is applied to wheels of the machine (e.g., via the reverse modulated brakes). As an example, the brake system may be used to provide ABS braking operations, TCS braking operations, and/or DSC braking operations, among other examples. Furthermore, the brake system may provide electrohydraulic braking operations that require an operator input to be blocked to implement the electrohydraulic braking operations (e.g., because the brake system may override an operator input to provide the automatic electrohydraulic braking operations).

For example, the brake system may, using one or more valves as described in more detail elsewhere herein, prevent the reverse modulated brakes from receiving a brake pressure that is based on a hydro-mechanical pressure signal and may enable the reverse modulated brakes to receive a brake pressure that is based on an electrohydraulic pressure signal (e.g., that is based on an electronic input). In this way the brake system may provide automatic electrohydraulic braking operations that require an operator input to be blocked to implement the automatic electrohydraulic braking operations, such as ABS braking operations.

Embodiments of the disclosed subject matter can also be as set forth according to the following parentheticals.

(1) A brake system of a machine, the brake system comprising: a reverse modulated brake operatively connected to a wheel of the machine; a relay valve, in fluid communication with the reverse modulated brake, for supplying, to the reverse modulated brake, at least one of a de-apply pressure that causes the reverse modulated brake to be in a de-applied position or an apply pressure that causes the reverse modulated brake to be in an applied position, wherein the apply pressure is based on at least one of a hydro-mechanical pressure signal or an electrohydraulic pressure signal, and wherein the apply pressure is lower than the de-apply pressure; a hydraulic logic element, in fluid communication with the relay valve, for supplying the at least one of the hydro-mechanical pressure signal or the electrohydraulic pressure signal to the relay valve, wherein the hydraulic logic element includes a first inlet and a second inlet; a hydro-mechanical valve, in fluid communication with the first inlet, for outputting the hydro-mechanical pressure signal to the first inlet; an electrohydraulic valve, in fluid communication with the second inlet, for outputting the electrohydraulic pressure signal to the second inlet; and a blocking valve, in fluid communication with the hydraulic logic element and the hydro-mechanical valve, that is movable between a closed position and an open position, wherein, when the blocking valve is in the closed position, the hydro-mechanical valve is not in fluid communication with the first inlet, and wherein the first inlet is in fluid communication with a tank associated with the brake system.

(2) The brake system according to (1), wherein the hydraulic logic element is a shuttle valve that outputs a higher-pressure signal of the hydro-mechanical pressure signal and the electrohydraulic pressure signal.

(3) The brake system according to any one of (1) to (2), further comprising: a controller configured to: receive, from a sensor device of the machine, stability data associated with the wheel of the machine; set an electronic stability braking mode to an active status; cause, based on the active status, the blocking valve to move to the closed position; determine a corrected apply pressure; and cause the electrohydraulic valve to output the electrohydraulic pressure signal that is based on the corrected apply pressure.

(4) The brake system according to any one of (1) to (3), wherein the electrohydraulic valve is an electronic pressure reducing valve (ePRV).

(5) The brake system according to any one of (1) to (4), wherein the electrohydraulic valve is associated with at least one of: an antilock brake system, a traction control system, or a dynamic stability control system.

(6) The brake system according to any one of (1) to (5), further comprising:

an accumulator operatively connected to at least one of: the relay valve, or the electrohydraulic valve.

(7) The brake system according to any one of (1) to (6), wherein the reverse modulated brake is a spring applied and hydraulically released brake.

(8) A method for enhanced reverse modulated brake control for a machine, comprising: receiving, by a brake system of the machine, stability data associated with multiple wheels of the machine; initiating, by the brake system and based on the stability data, an automatic electrohydraulic braking operation associated with a brake that is operatively connected to a wheel, of the multiple wheels, wherein the brake is movable from a de-applied position to an applied position to apply a brake force to the wheel; preventing, by the brake system and based on initiating the automatic electrohydraulic braking operation, an operator input from controlling a brake pressure that is supplied to the brake via a relay valve of the brake system; and decreasing, by the brake system and based on an electrohydraulic pressure signal, the brake pressure that is supplied to the brake, via the relay valve, to move the brake from the de-applied position to the applied position to apply the brake force to the wheel.

(9) The method according to (8), wherein the electrohydraulic pressure signal is provided by an electrohydraulic pressure reducing valve (ePRV).

(10) The method according to any one of (8) to (9), wherein preventing, by the brake system, the operator input from controlling the brake pressure that is supplied to the brake, via the relay valve, comprises: closing, by the brake system, a blocking valve that causes a pressure associated with the operator input to be lower than a pressure associated with the electrohydraulic pressure signal.

(11) The method according to any one of (8) to (10), further comprising: stopping the automatic electrohydraulic brake operation; and enabling the operator input to control the brake pressure that is supplied to the brake, via the relay valve.

(12) The method according to any one of (8) to (11), wherein the automatic electrohydraulic braking operation is associated with at least one of: an antilock brake system, a traction control system, or a dynamic stability control system.

(13) The method according to any one of (8) to (12), wherein the stability data is associated with at least one of: a wheel slip event, a wheel skid event, an oversteer event, an understeer event, or a rollover prevention event.

(14) The method according to any one of (8) to (13), wherein the brake force is provided via a mechanical spring of the brake.

(15) A machine having one or more wheels, comprising: a brake system, the brake system including: a relay valve in fluid communication with a brake that is operatively connected to a wheel, of the one or more wheels, wherein the relay valve is associated with providing, to the brake, at least one of: a release brake pressure associated with maintaining the brake in a de-applied position, or a modulated brake pressure, that is less than the release brake pressure, associated with causing the brake to move from the de-applied position to an applied position to apply a brake force to the wheel, and wherein the modulated pressure is based on at least one of a hydro-mechanical pressure signal or an electrohydraulic pressure signal; a hydro-mechanical valve in fluid communication with the relay valve, wherein the hydro-mechanical valve provides, and the relay valve receives, the hydro-mechanical pressure signal in response to receiving a hydro-mechanical input; an electrohydraulic valve in fluid communication with the relay valve, wherein the electrohydraulic valve provides, and the relay valve receives, the electrohydraulic pressure signal in response to receiving an electronic input; and a blocking valve positioned in fluid communication between the hydro-mechanical valve and the relay valve, wherein the blocking valve is movable between a closed position that prevents the relay valve from receiving the hydro-mechanical pressure signal from the hydro-mechanical valve and an open position that enables the relay valve to receive the hydro-mechanical pressure signal from the hydromechanical valve.

(16) The machine according to (15), wherein electrohydraulic valve is an electronic pressure reducing (ePRV) valve.

(17) The machine according to any one of (15) to (16), wherein the electronic input is associated with an automatic electrohydraulic braking operation.

(18) The machine according to any one of (15) to (17), wherein the electronic input is received from at least one of: an antilock brake system, a traction control system, or a dynamic stability control system.

(19) The machine according to any one of (15) to (18), wherein the brake is a spring applied and hydraulically released brake.

(20) The machine according to any one of (15) to (19), wherein the machine is an underground articulated truck.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A brake system of a machine, the brake system comprising:
a reverse modulated brake operatively connected to a wheel of the machine;
a relay valve, in fluid communication with the reverse modulated brake, for supplying, to the reverse modulated brake, at least one of a de-apply pressure that causes the reverse modulated brake to be in a de-applied position or an apply pressure that causes the reverse modulated brake to be in an applied position,
wherein the apply pressure is based on at least one of a hydro-mechanical pressure signal or an electrohydraulic pressure signal, and
wherein the apply pressure is lower than the de-apply pressure;
a hydraulic logic element, in fluid communication with the relay valve, for supplying the at least one of the hydro-mechanical pressure signal or the electrohydraulic pressure signal to the relay valve,
wherein the hydraulic logic element includes a first inlet and a second inlet;
a hydro-mechanical valve, in fluid communication with the first inlet, for outputting the hydro-mechanical pressure signal to the first inlet;
an electrohydraulic valve, in fluid communication with the second inlet, for outputting the electrohydraulic pressure signal to the second inlet; and
a blocking valve, in fluid communication with the hydraulic logic element and the hydro-mechanical valve, that is movable between a closed position and an open position,
wherein, when the blocking valve is in the closed position, the hydro-mechanical valve is not in fluid communication with the first inlet, and
wherein the first inlet is in fluid communication with a tank associated with the brake system.

2. The brake system of claim 1, wherein the hydraulic logic element is a shuttle valve that outputs a higher-pressure signal of the hydro-mechanical pressure signal and the electrohydraulic pressure signal.

3. The brake system of claim 1, further comprising:
a controller configured to:
receive, from a sensor device of the machine, stability data associated with the wheel of the machine;
set an electronic stability braking mode to an active status;
cause, based on the active status, the blocking valve to move to the closed position;
determine a corrected apply pressure; and
cause the electrohydraulic valve to output the electrohydraulic pressure signal that is based on the corrected apply pressure.

4. The brake system of claim 1, wherein the electrohydraulic valve is an electronic pressure reducing valve (ePRV).

5. The brake system of claim 1, wherein the electrohydraulic valve is associated with at least one of:
an antilock brake system,
a traction control system, or
a dynamic stability control system.

6. The brake system of claim 1, further comprising:
an accumulator operatively connected to at least one of:
the relay valve, or
the electrohydraulic valve.

7. The brake system of claim 1, wherein the reverse modulated brake is a spring applied and hydraulically released brake.

8. A method for enhanced reverse modulated brake control for a machine, comprising:
receiving, by a brake system of the machine, stability data associated with multiple wheels of the machine;
initiating, by the brake system and based on the stability data, an automatic electrohydraulic braking operation associated with a brake that is operatively connected to a wheel, of the multiple wheels,
wherein the brake is movable from a de-applied position to an applied position to apply a brake force to the wheel;
preventing, by the brake system and based on initiating the automatic electrohydraulic braking operation, an operator input from controlling a brake pressure that is supplied to the brake via a relay valve of the brake system; and
decreasing, by the brake system and based on an electrohydraulic pressure signal, the brake pressure that is supplied to the brake, via the relay valve, to move the brake from the de-applied position to the applied position to apply the brake force to the wheel.

9. The method of claim 8, wherein the electrohydraulic pressure signal is provided by an electrohydraulic pressure reducing valve (ePRV).

10. The method of claim 8, wherein preventing, by the brake system, the operator input from controlling the brake pressure that is supplied to the brake, via the relay valve, comprises:
closing, by the brake system, a blocking valve that causes a pressure associated with the operator input to be lower than a pressure associated with the electrohydraulic pressure signal.

11. The method of claim 8, further comprising:
stopping the automatic electrohydraulic brake operation; and
enabling the operator input to control the brake pressure that is supplied to the brake, via the relay valve.

12. The method of claim 8, wherein the automatic electrohydraulic braking operation is associated with at least one of:
an antilock brake system,
a traction control system, or
a dynamic stability control system.

13. The method of claim 8, wherein the stability data is associated with at least one of:
a wheel slip event,
a wheel skid event,
an oversteer event,
an understeer event, or
a rollover prevention event.

14. The method of claim 8, wherein the brake force is provided via a mechanical spring of the brake.

15. A machine having one or more wheels, comprising:
a brake system, the brake system including:
a relay valve in fluid communication with a brake that is operatively connected to a wheel, of the one or more wheels,
wherein the relay valve is associated with providing, to the brake, at least one of:
a release brake pressure associated with maintaining the brake in a de-applied position, or
a modulated brake pressure, that is less than the release brake pressure, associated with causing the brake to move from the de-applied position to an applied position to apply a brake force to the wheel, and
wherein the modulated pressure is based on at least one of a hydro-mechanical pressure signal or an electrohydraulic pressure signal;
a hydro-mechanical valve in fluid communication with the relay valve,
wherein the hydro-mechanical valve provides, and the relay valve receives, the hydro-mechanical pressure signal in response to receiving a hydro-mechanical input;
an electrohydraulic valve in fluid communication with the relay valve,
wherein the electrohydraulic valve provides, and the relay valve receives, the electrohydraulic pressure signal in response to receiving an electronic input; and
a blocking valve positioned in fluid communication between the hydro-mechanical valve and the relay valve,
wherein the blocking valve is movable between a closed position that prevents the relay valve from receiving the hydro-mechanical pressure signal from the hydro-mechanical valve and an open position that enables the relay valve to receive the hydro-mechanical pressure signal from the hydromechanical valve.

16. The machine of claim 15, wherein electrohydraulic valve is an electronic pressure reducing (ePRV) valve.

17. The machine of claim 15, wherein the electronic input is associated with an automatic electrohydraulic braking operation.

18. The machine of claim 15, wherein the electronic input is received from at least one of:
an antilock brake system,
a traction control system, or
a dynamic stability control system.

19. The machine of claim 15, wherein the brake is a spring applied and hydraulically released brake.

20. The machine of claim 15, wherein the machine is an underground articulated truck.
